(19) United States
(12) Patent Application Publication
(10) Pub. No.: US 2008/0118778 A1
(43) Pub. Date: May 22, 2008

(54) Magnetoresistive reproducing magnetic head and magnetic recording apparatus utilizing the head

(75) Inventors: Hideyuki Akimoto, Kawasaki (JP); Naoki Mukoyama, Kawasaki (JP); Jun Masuko, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/982,935

(22) Filed: Nov. 5, 2007

(30) Foreign Application Priority Data
Nov. 16, 2006 (JP) 2006-310731

(51) Int. Cl. G11B 5/39

(52) U.S. Cl. 428/811.2; 360/250

(57) ABSTRACT

A magnetoresistive reproducing head includes first and second free magnetic layers. A non-magnetic layer is provided between the first and second free magnetic layers. A bias applying layer having a single region applies a bias magnetic field in a direction perpendicular to the medium facing plane of the first free-magnetic layer and the second free-magnetic layer. An electrode is electrically connected to the first free-magnetic layer, the second free-magnetic layer, and the non-magnetic layer. In response to a magnetic field generated when a current is applied to the first free-magnetic layer, the second free-magnetic layer, and the non-magnetic layer in a direction perpendicular to the medium facing plane, magnetizations of the first free-magnetic and the second free-magnetic layer are tilted in opposite directions from a direction perpendicular to the medium facing plane.

The present invention relates to a reproducing magnetic head and a magnetic recording apparatus utilizing the head, and more specifically, to highly sensitive magnetoresistive reproducing magnetic heads.

### BACKGROUND OF THE INVENTION

In recent years, a larger capacity recording apparatus is required for processing digital signals and increased quantities of information, and rapid progress in recording density has occurred in the development of magnetic recording apparatus such as a hard disk drive (HDD). Several years ago, inductive heads were used for both reading and writing. To increase storage capacity, bit size for recording to a magnetic recording medium (hereinafter, referred to as a recording medium or simply as a medium) was reduced and magnetic flux of a signal read from the recording medium was also reduced in size. However, inductive heads for reading a medium signal by using the electromagnetic inductive effect through a ring core of the related art could not sufficiently read the weak medium signals produced.

Accordingly, a magnetoresistive reproducing magnetic head (MR head) has been used. An MR head is capable of reading a medium signal because its resistance changes when magnetization of a magnetic thin film rotates in response to a magnetic field produced by a medium.

Among such MR heads, a gigantic magnetoresistive (GMR) head having a sensitivity of about two times the sensitivity of the magnetoresistive head of the related art has been widely used. The GMR head includes a laminated structure having a free-magnetic layer, a non-magnetic layer and a fixed magnetic layer, that is, a spin-valve type reproducing magnetic head.

However, recording apparatus having an even larger storage capacity is desired and such a large increase in recording density is required that a medium signal cannot be properly sensed even with a spin-valve type reproducing magnetic head. Accordingly, a tunnel type magnetoresistive reproducing magnetic head having still higher sensitivity, and a current perpendicular-to-the-plane (CPP) type magnetoresistive reproducing magnetic head for applying a current in the perpendicular direction of the film plane have been developed.

FIGS. 1(a)-1(c) show a spin-valve type magnetoresistive element of the related art. FIG. 1(b) is a cross-sectional view cut at a central area of the element of FIG. 1(a), and FIG. 1(c) is a side elevation view of the element of FIG. 1(a) observed from a medium facing plane which is parallel to the bottom of the element as seen in FIG. 1(a). An element 1 has a free-magnetic layer 2 which rotates its magnetization in response to a magnetic field of a medium, a fixed magnetic layer 3 which is fixed in a direction of magnetization, and a non-magnetic layer 5 provided between the free-magnetic layer 2 and the fixed-magnetic layer 3. The element 1 also includes an anti-ferromagnetic layer 4 which fixes the fixed-magnetic layer 3 through exchange coupling. A bias applying layer 6 having two separate regions 6a, 6b is positioned adjacent an underlayer 7 in the right and left sides of the element 1. The regions 6a, 6b of the bias layer 6 combine to apply a bias magnetic field to the free-magnetic layer 2. Barkhausen noise is suppressed by control of the magnetic domain of the free-magnetic layer 2. Moreover, a current terminal (not illustrated) may be connected electrically to the bias applying layer 6.

Next, FIGS. 2(a)-2(c) include schematic diagrams showing magnetizing conditions of the free-magnetic layer and the fixed-magnetic layer of the spin-valve type reproducing magnetic head of the related art. FIGS. 2(a)-2(c) do not illustrate the layers other than the free-magnetic layer 2 and fixed-magnetic layer 3. FIG. 2(a) illustrates a magnetizing condition wherein a magnetic field changes along a track in a medium (indicated by arrows pointing in the same direction parallel to a medium facing plane 9) is not provided. In this condition, a magnetizing direction of the free-magnetic layer 2 is parallel to the medium facing plane 9 due to the influence of magnetic anisotropy and the influence of the bias magnetic field from the bias applying layer 6. Meanwhile, magnetization of the fixed-magnetic layer 3 is fixed in the direction perpendicular to the medium facing plane 9 due to exchange coupling with the anti-ferromagnetic layer 4. The magnetizing direction of the fixed-magnetic layer 3 also may be opposite by 180°.

In a case where a medium magnetic field 8 exists, the magnetizing direction of the free-magnetic layer 2 rotates in response to the medium magnetic field 8, as shown in FIG. 2(b) or FIG. 2(c), depending on how the magnetic field in the medium changes. On the other hand, a magnetizing direction of the fixed-magnetic layer 3 is still fixed in the direction perpendicular to the medium facing plane 9 due to exchange coupling with the anti-ferromagnetic layer 4. Accordingly, a relative angle θ of magnetization of the free-magnetic layer and fixed-magnetic layer changes in accordance with the medium magnetic field 8. A dashed arrow corresponding to the magnetization direction in the fixed-magnetic layer 3 (11 in FIGS. 3(a)-3(c)) is used to illustrate the relative angle θ in the free-magnetic layer 2 in FIGS. 2(a)-2(c). Resistance of the element also changes in accordance with the magnetoresistive effect. Magnetic information on the recording medium is converted to an electric signal using such changes of resistance.

When the spin-valve type reproducing magnetic head and the tunnel magnetoresistive reproducing magnetic head of the related art are used, the fixed-magnetic layer 3 does not respond to the medium magnetic field and a medium signal can be read as a change of resistance through rotation of only a single soft-magnetic layer (free-magnetic layer 2).

However, when magnetizing directions of a pair of soft-magnetic layers 10 and 11 (FIGS. 3(a)-3(c)) are respectively rotated in opposite directions in response to the medium magnetic field 8, a reproducing output can be almost doubled because the relative angle of magnetization θ of the pair of soft-magnetic layers 10 and 11 is almost double as compared with that of the related art. When the magnetic field of the medium does not exist (FIG. 3(a)), the magnetizing directions of the free-magnetic layers 10 and 11 are opposed with each other and are designed to have an angle of elevation φ of about 45° with respect to a plane 29 parallel to the medium facing plane 9. FIGS. 3(a)-3(c) do not illustrate any layers other than the first free-magnetic layer 10 and the second free-magnetic layer 11, but a non-magnetic layer is also provided between the first free-magnetic layer and the second magnetic-layer to form an electromagnetic element.

Meanwhile, in a case where the medium magnetic field 8 exists (vertically away from the plane 9 in FIG. 3(b) and towards the plane 9 in FIG. 3(c)), magnetizing directions of the free-magnetic layers 10 and 11 are respectively rotated in the vertical direction with respect to the medium facing plane 9 in response to the medium magnetic field 8, as shown in FIG. 3(b) and FIG. 3(c). As an example, Japanese Patent Publication No. 3657916 discloses a reproducing magnetic head for a vertical medium utilizing such a pair of anti-ferromagnetic layers of different blocking temperatures.

However, in the case where both end portions of the first free-magnetic layer and the second free-magnetic layer are fixed using a pair of anti-ferromagnetic layers of different blocking temperatures, a thickness of about 5 nm to 20 nm is required for the anti-ferromagnetic layers. Such a thickness of the anti-ferromagnetic layers creates a significant problem in realizing a narrow gap for high density recording.

Moreover, the regions of the bias applying layer arranged on both sides of the element suppress Barkhausen noise by applying a bias magnetic field to the free-magnetic layers. However, in this case, the result of such an arrangement is lower sensitivity of the free-magnetic layer to the medium magnetic field and reduction in reproducing output.

FIG. 4 is a distribution diagram of a bias magnetic field in the core width direction of the free-magnetic layers for reproducing magnetic heads having different element core widths. FIG. 4 shows simulation results when the size in the element core width direction is 88 nm, 148 nm, and 200 nm, a height of the element is 112 nm, and a product of a thickness t and a residual magnetization Br (tBr) of the ferromagnetic layer as the bias applying layer is 190 Gμm. The direction indicated by the arrow mark “a” in FIG. 1 is called the element core width direction and the direction indicated by the arrow marked “b” is called the element height direction. When the element core width is 148 nm and 200 nm, a bias magnetic field at the center of the element is 20 Oe or less, but when the element core width is 88 nm, many regions are under the control of a magnetic domain when the bias field from the ferromagnetic layer and the bias magnetic field at the center of the element is 100 Oe or more.

To read fine magnetic information recorded in a high density magnetic disk, the magnetoresistive element is also reduced in size. FIG. 4 shows how reduction in output due to the bias magnetic field from the bias applying layer becomes a significant problem when designing smaller magnetoresistive elements, such as the element having an 88 nm core width direction size.

Accordingly, it is desirable to provide a high sensitivity magnetoresistive reproducing magnetic head formed with a pair of free-magnetic layers in order to solve the problem explained above, and also to provide a magnetic recording apparatus utilizing the head. It is also desirable to provide a high sensitivity magnetoresistive reproducing magnetic head generally similar to the structures suffering from a reduction in output due to the bias applying layer, and also to provide a magnetic recording apparatus utilizing the head.

### SUMMARY OF THE INVENTION

A reproducing magnetic head includes a first free-magnetic layer, a second free-magnetic layer, and a non-magnetic layer provided between the first free-magnetic layer and the second free-magnetic layer. Also included is a bias applying layer having a single region adjacent at least one of the first and second free magnetic layers for applying a bias magnetic field in the direction perpendicular to the medium facing plane of the first free-magnetic layer and the second free-magnetic layer, and an electrode electrically connected to the first free-magnetic layer, the second free-magnetic layer, and the non-magnetic layer. Magnetizations of the first free-magnetic layer and the second free-magnetic layer are tilted in opposite directions within a film plane of each free-magnetic layer from the direction perpendicular to the medium facing plane with a magnetic field generated when a current is applied to the first free-magnetic layer, the second free-magnetic layer, and the non-magnetic layer in the direction perpendicular to the medium facing plane.

In the structure explained above, magnetizing directions of the first free-magnetic layer and the second free-magnetic layer are opposed to each other, with a bias magnetic field from a single region of the bias applying layer and a magnetic field generated from the current tilted in the desired elevation angle from the medium facing plane. Moreover, a soft magnetic film usually generates a magnetic domain but magnetizations of the first free-magnetic layer and the second free-magnetic layer do not generate the magnetic domain due to the bias magnetic field from the bias applying layer.

Accordingly, a magnetizing direction of each free-magnetic layer responds to the medium magnetic field by rotating and becoming parallel or anti-parallel to such a medium magnetic field. Thereby, relative angles in magnetization of the first free-magnetic layer and the second free-magnetic layer are almost twice that of the reproducing magnetic head of the structure of the related art. As a result, the reproducing output obtained can be almost doubled.

Moreover, magnetizations of the first free-magnetic layer and the second free-magnetic layer are tilted in opposite directions by 30° to 60° in terms of an elevation angle for respective medium facing planes within the film plane of each free-magnetic layer. Therefore, an improved reproducing output can be obtained under the conditions explained above.

Moreover, the bias applying layer is electrically connected, on the side of the head opposite of the medium facing plane, with the first free-magnetic layer, second free-magnetic layer, and the non-magnetic layer. The bias applying layer also operates as an electrode. Since the bias applying layer is arranged on the side of the head away from the medium facing plane, reduction of output due to excessive control of the magnetic domain by the bias applying layer can be prevented with less control of the magnetic domain to each free-magnetic layer at the area near the medium facing plane, each free-magnetic layer having a larger sensitivity to the medium magnetic field.

The magnetic recording apparatus of the present invention includes a magnetic disk, and a reproducing magnetic head for reading recorded information from the disk. A flexible suspension is bonded to the reproducing magnetic head, and an actuator arm freely rotates the suspension. A detecting circuit device which is electrically connected to the reproducing magnetic head through an insulated wire on the suspension and the actuator arm detects an electrical signal read from the magnetic disk with the reproducing magnetic head. The magnetic recording apparatus utilizes the reproducing magnetic head of the present invention.

According to the magnetoresistive reproducing magnetic head of the present invention, a relatively high output can be obtained and a reproducing magnetic head suitable for high recording density and a large capacity magnetic recording apparatus can be provided.

### BRIEF DESCRIPTION OF THE DRAWINGS

The present invention will be explained with reference to the accompanying drawings.

FIG. 1(a) is a side elevation view showing a structure of a conventional magnetoresistive element, FIG. 1(b) is a cross-sectional view cut at a central area of the element of FIG. 1(a), and FIG. 1(c) is a side elevation view of the element of FIG. 1(a) observed from a medium facing plane.

FIGS. 2(a)-2(c) are diagrams showing the magnetizing conditions of the free-magnetic layer and fixed-magnetic layer of a spin-valve type reproducing magnetic head of the related art.

FIGS. 3(a)-3(c) are schematic diagrams showing the magnetizing conditions of the first free-magnetic layer and second magnetic-layer of a reproducing magnetic head having a first free-magnetic layer and a second free-magnetic layer.

FIG. 4 is a distribution graph of the bias magnetic field in the longitudinal direction of the free-magnetic layer for several element configurations.

FIG. 5(a) is a side elevation of the reproducing magnetic head of the first embodiment of the present invention observed from the direction parallel to the film plane.

FIG. 5(b) is a cross-sectional view of the reproducing magnetic head of the first embodiment cut at the center of the element.

FIG. 5(c) is a side elevation of the reproducing magnetic head of the first embodiment observed from the medium facing plane.

FIGS. 6(a)-6(b) are schematic diagrams showing the magnetizing conditions of the first free-magnetic layer and the second free-magnetic layer of the reproducing magnetic head of the first embodiment.

FIG. 7 is diagram showing the relationship among rotating angle of the free-magnetic layer, asymmetry of the reproducing waveform, and tBr of the bias applying layer in the related art.

FIG. 8 is a perspective view of a magnetic recording apparatus using the reproducing magnetic head of the present invention.

FIGS. 9(a)-9(b) are schematic diagrams showing the positional relationships of the medium suspension, slider, and reproducing magnetic head of the present invention, and structures of the reproducing magnetic head and write magnetic head, respectively.

### DETAILED DESCRIPTION

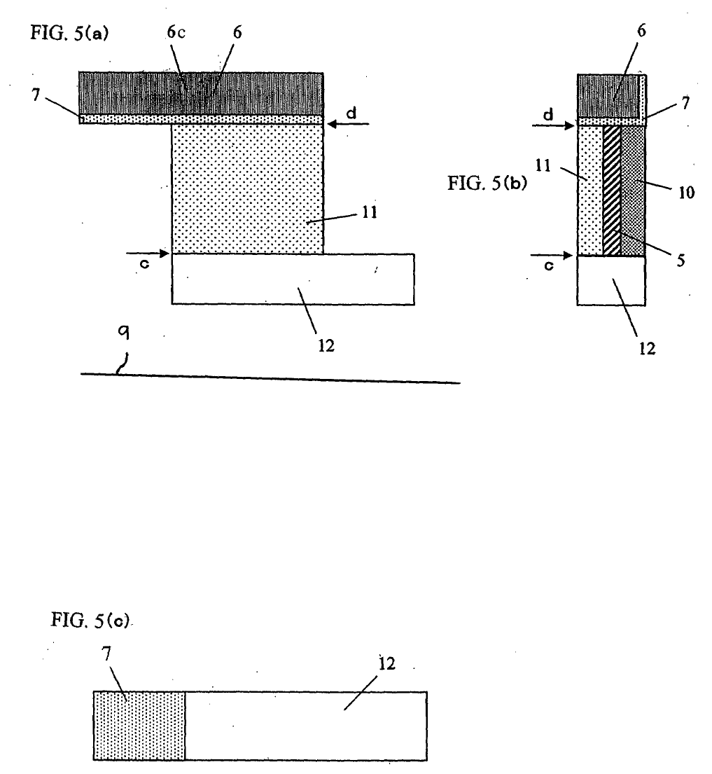

FIGS. 5(a)-(c) show a structure of the first embodiment of a reproducing magnetic head of the present invention.

The reproducing magnetic head is formed, for example, by laminating a lower shielding layer of NiFe or the like and an insulating layer of Al₂O₃ or the like on the Al₂O₃-TiC substrate, sequentially laminating and processing into the predetermined shape CoFe of about 4 nm as a first free-magnetic layer 10, Cu of about 1.5 nm as a non-magnetic layer 5, CoFe of about 4 nm as a second free-magnetic layer 11, and arranging CoCrPt of about 15 nm in a single region 6c as a bias applying layer 6 for applying the bias magnetic field to the first free-magnetic layer and the second magnetic layer via the underlayer 7 formed of Cr of about 1.5 nm to the side of the plane d opposed to the medium facing plane 9 and Ti of about 80 nm as a current terminal 12 on the side of the medium facing plane c.

The bias applying layer 6 may be formed in a laminating structure of a ferromagnetic layer of CoPt or the like, anti-ferromagnetic layer of PdPtMn, IrMn or the like and a soft magnetic layer of NiFe, CoFe or the like. The layer 6 may also be arranged without the underlayer 7. Moreover, the current terminal 12 may also be formed of W or the like, while the first free-magnetic layer or the second free-magnetic layer may be formed of NiFe or the like and the non-magnetic layer may be formed of an insulating material such as Al₂O₃, MgO or the like. In addition, an underlayer of Ta or the like and a cap layer of Ta or the like are also provided in some cases.

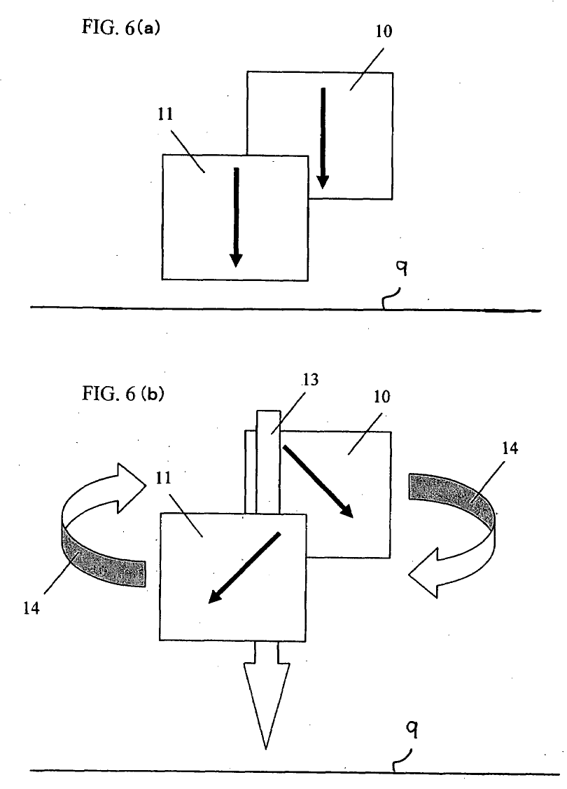

The reproducing magnetic head of this embodiment allows the single region 6c of the bias applying layer 6 to operate as another current terminal. When no current is applied to the current terminal, the first free-magnetic layer 10 and the second free-magnetic layer 11 are respectively magnetized toward the direction perpendicular to the medium facing plane, due to the bias magnetic field from the bias applying layer 6, as shown in FIG. 6(a). When a current 13 is applied to the reproducing magnetic head through the bias applying layer 6 as a current terminal and the current terminal 12, a magnetic field 14 due to a flow of current is generated. As a result, magnetizing directions of the first free-magnetic layer 10 and the second free-magnetic layer 11 are opposed to each other with an angle of elevation φ of about 45° (FIG. 6(b)) with respect to the medium facing plane c (FIG. 5(a)). However, since only a single region 6c is used to generate the bias magnetic field instead of multiple regions, the bias magnetic field has less influence on the magnetization of the first free-magnetic layer 10 and the second free-magnetic layer 11. The angle θ is in FIG. 6(b) is the relative angle between magnetizations of the first and second free-magnetic layers 10 and 11.

Next, response to the medium magnetic field of magnetization of the reproducing magnetic head of the present invention will be explained.

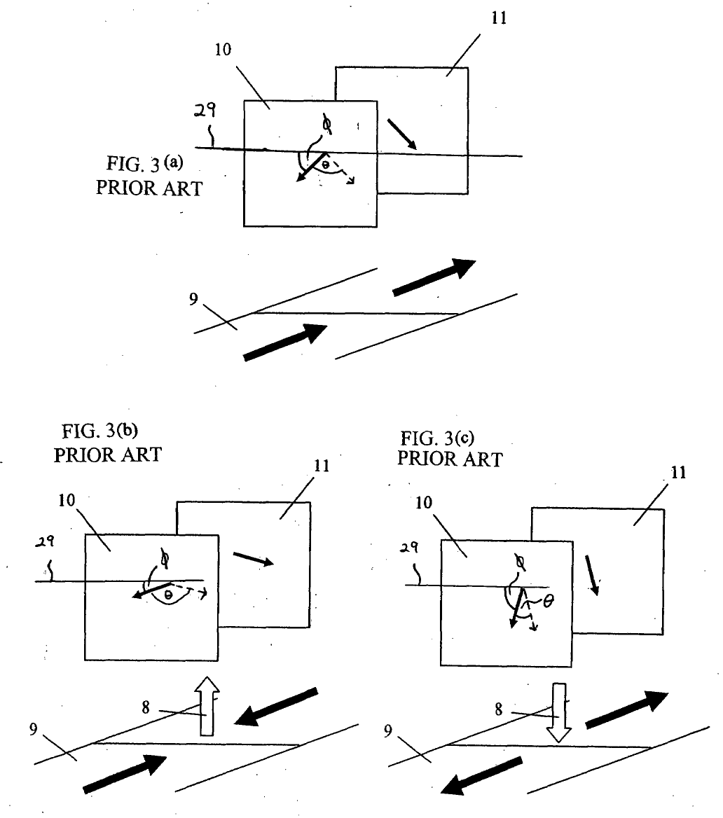

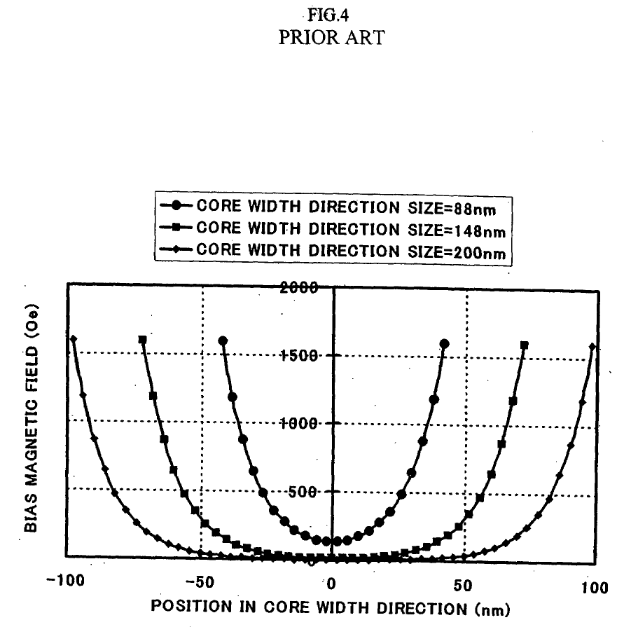

When a medium magnetic field does not exist, magnetizing directions of the first free-magnetic layer 10 and the second free-magnetic layer 11 are opposed to each other with an angle of elevation of about 45° from the medium facing plane due to the magnetic field generated from the current and the bias magnetic field from the bias applying layer, as shown in FIG. 3(a).

Next, when the medium magnetic field 8 is applied as shown in FIG. 3(b), the first free-magnetic layer 10 and the second free-magnetic layer 11 rotate to form an angle of elevation φ for the medium facing plane that is an acute angle, resulting in a larger relative angle θ between these layers. Meanwhile, when the medium magnetic field is applied as shown in FIG. 3(c), the first free-magnetic layer 10 and the second free-magnetic layer 11 rotate in the direction forming a larger angle of elevation φ for the medium facing plane, resulting in a smaller relative angle between these layers.

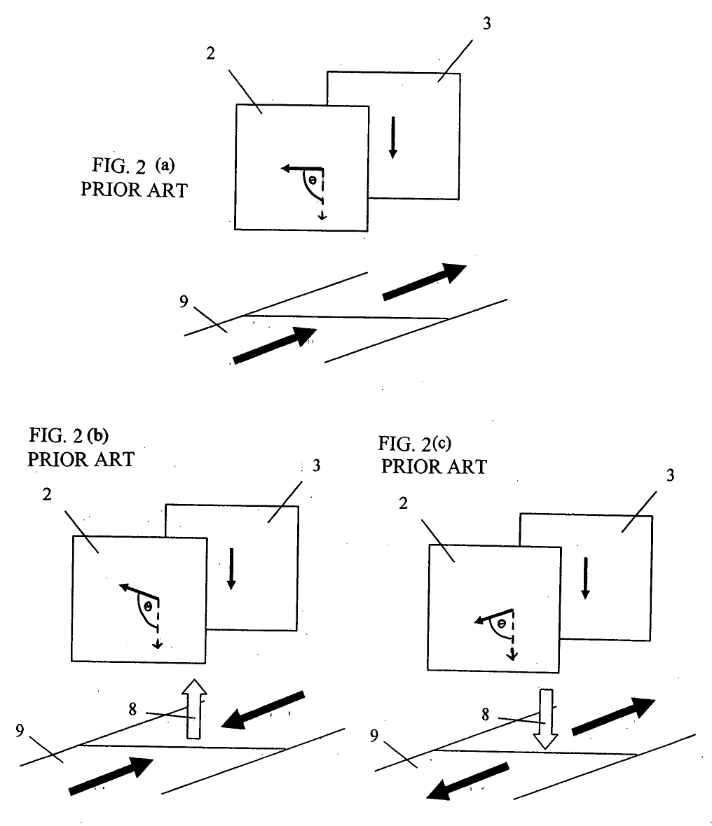

In the related art of FIGS. 2(a)-2(c), only the free-magnetic layer rotates in response to the medium magnetic field. However, in the case of the reproducing magnetic head of the present invention, the first free-magnetic layer 10 and the second free-magnetic layer 11 rotate respectively in opposite directions in response to the medium magnetic field. Accordingly, a change in the relative angle θ is almost doubled in comparison with that in the related art. Therefore, a reproducing output is also almost doubled in comparison with that in the related art of FIGS. 2(a)-2(c).

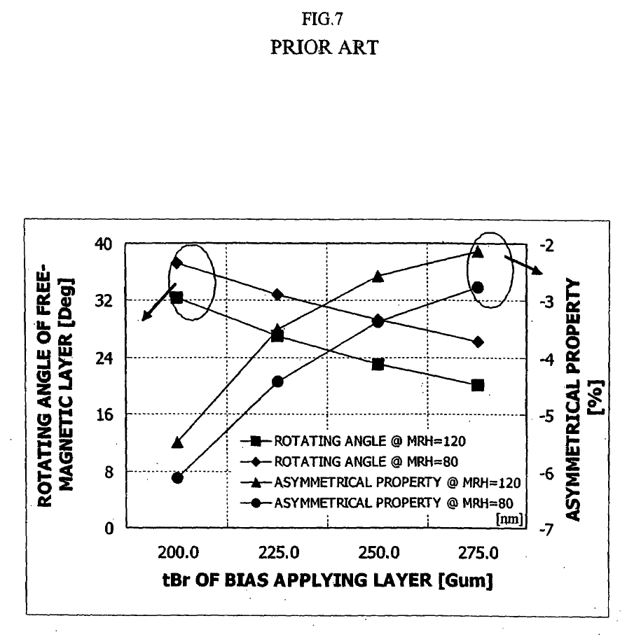

FIG. 7 shows relationships among the rotating angle of the free-magnetic layer, asymmetrical property of the reproducing waveform and a tBr of a bias applying layer in the reproducing magnetic head in the related art. A rotating angle of the free-magnetic layer corresponds to the maximum rotating angle of the free-magnetic layer rotating due to the medium magnetic field. FIG. 7 shows the results of a reproducing output simulation of the reproducing magnetic head under the conditions that a core width is set to 84 nm, an element height is set to 80 nm or 120 nm, and a distance between the reproducing magnetic head and medium is set to 14 nm.

When a tBr of the bias applying layer is reduced, the bias magnetic field applied to the free-magnetic layer becomes small, and the rotating angle of the free-magnetic layer corresponding to the medium magnetic field becomes larger. However, control of the magnetic domain of the free-magnetic layer is also reduced, resulting in a possible generation of Barkhausen noise. When Barkhausen noise is generated, an asymmetrical property of the reproducing waveform or output becomes larger. This asymmetrical property is preferably set within ±5%. When the asymmetrical property is set to ±5% from FIG. 7, the rotating angle of the free-magnetic layer is restricted to the range of 30° to 34°.

Here, a reproducing output of the reproducing magnetic head is expressed with the following formula (1).

V=(1/2)×ΔR×(1−cos θ)×Is (1)

Here, V is a reproducing output, ΔR is change in the magnetic resistance, θ is a relative angle between the first free-magnetic layer and the second free-magnetic layer, and Is is a sense current. From the description herein, it is desirable that the magnetizing direction of the first free-magnetic layer and the second free-magnetic layer is rotating at an angle equal to 30° or less for the medium magnetic field. As a result, if the medium magnetic field does not exist, excellent reproducing output can be obtained through magnetization of the first free-magnetic layer 10 and the second free-magnetic layer 11 by setting the angle of elevation with respect to the medium facing plane c to an angular range of 30° to 60°. The reason for this setting is that when the angle of elevation with respect to the medium facing plane c is set to 30° or less, the first free-magnetic layer and the second free-magnetic layer are anti-parallel with the medium magnetic field. Meanwhile, when the angle of elevation with respect to the medium facing plane c is set to 60° or more, the first free-magnetic layer and the second free-magnetic layer become parallel with the medium magnetic field and a linear reproducing output can no longer be obtained.

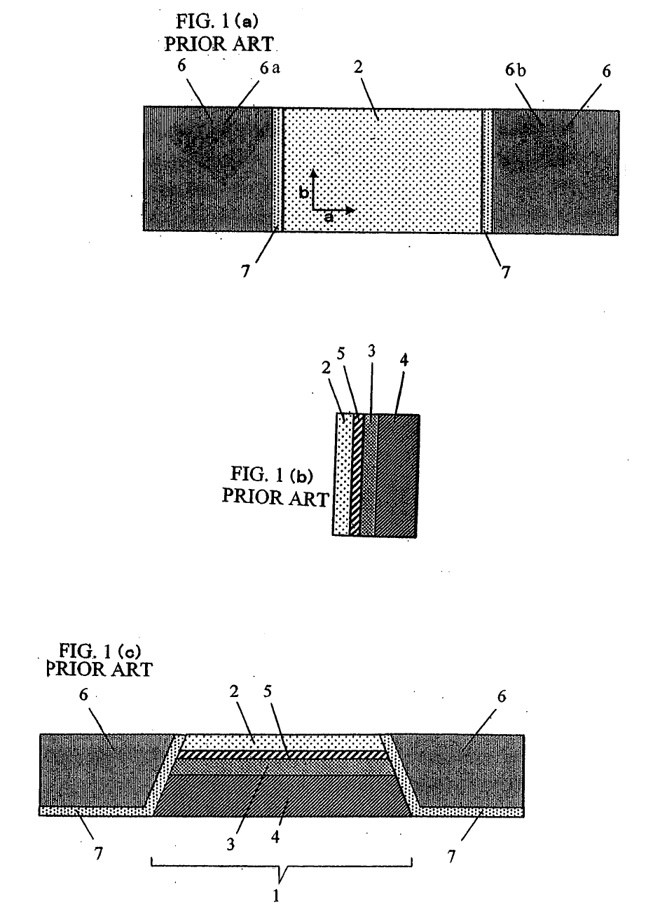

Moreover, in the related art, rotation of the magnetizing direction of the free-magnetic layer 2 at both ends of the element is reduced because the magnetic field from the dual regions 6a, 6b of the bias applying layer 6 is applied at both ends of the element, as shown in FIG. 1. Particularly, in the reproducing magnetic head including a core having a narrow width, rotating of the magnetizing direction of the free-magnetic layer 2 is also reduced even at the center of the element. However, in this embodiment of the present invention, magnetization of the first free-magnetic layer 10 and the second free-magnetic layer 11 at the side of the plane d opposing the medium facing plane c is subject to stronger control of the magnetic domain by the magnetic field from the bias applying layer, and magnetization of the first free-magnetic layer 10 and the second free-magnetic layer 11 is less controlled by the bias applying layer in the side of the medium facing plane c because only one region 6c is used, resulting in higher sensitivity to the medium magnetic field. Accordingly, the magnetizing direction is rotated to a large extent and thereby a larger output can be obtained.

In this embodiment, magnetization of the first free-magnetic layer and the second free-magnetic layer is conducted without any influence thereon due to the element core width direction. Therefore, a large anti-magnetic field is not generated and significant Barkhausen noise is not generated even though the bias applying layer does not have regions on both end portions of the element.

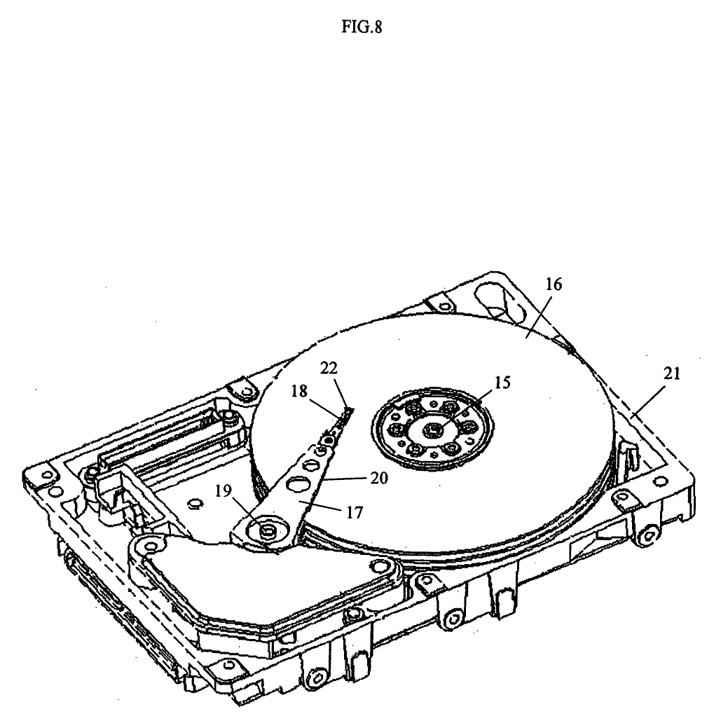

Here, a magnetic recording apparatus loading the reproducing magnetic head of this embodiment will be explained briefly. FIG. 8 is a perspective view of a magnetic recording apparatus using the reproducing magnetic head of this embodiment. A magnetic disk 16 includes magnetic information and is rotated at a high velocity by a spindle motor 15. An actuator arm 17 is provided with a suspension 18 formed of flexible stainless steel. The actuator arm 17 is fixed to a housing 21 to freely rotate through a pivot 19 and can move in approximately the radius direction of the magnetic disk 16. Accordingly, a slider 22 mounted to the suspension 18 moves over the magnetic disk 16 for recording and reproducing information over the predetermined track.

The housing 21 accommodates a fixed detecting circuit device for detecting the recording/reproducing signals. The detecting circuit device detects changes in the resistance value of the magnetoresistive element and recovers information from the medium by feeding a sense current to the magnetoresistive element of the reproducing magnetic head and measuring changes in voltage across the magnetoresistive element.

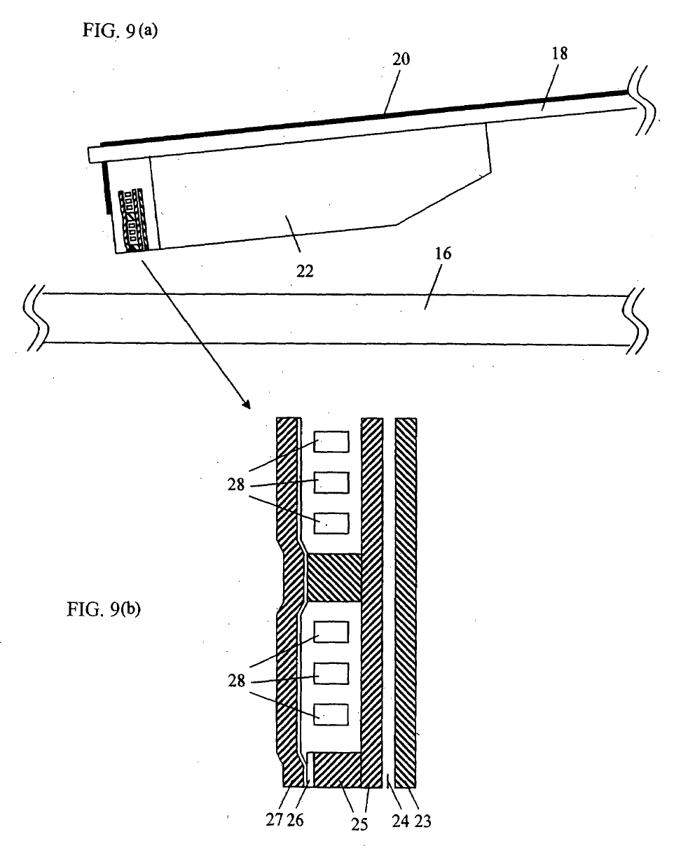

FIG. 9(a) is a schematic diagram showing the positional relationship between the suspension 18, slider 22 of FIG. 8 and the reproducing magnetic head of the embodiment of FIG. 6. The slider 22 is mounted to the suspension 18 at the lower part thereof in order to form a head suspension assembly. When the magnetic disk 16 rotates at a high velocity, air is pressurized and directed into a gap between the slider 22 and the magnetic disk 16, and the slider 22 floats due to such pressurized air. The reproducing magnetic head mounted at the end part of the slider 22 is electrically connected to a detecting circuit device via an insulated conductive wire 20 over the suspension 18 and actuator arm 17.

FIG. 9(b) shows a reproducing magnetic head and a write magnetic head of the embodiment shown in FIG. 5 and FIG. 6. The reproducing magnetic head 24 is formed in the structure that it is held between a lower shield 23 and an upper shield 25. The reproducing magnetic head 24 is arranged adjacent to the write magnetic head formed with a lower magnetic pole 25 also working as the upper shield and a coil 28 for recording and which is arranged on both sides of a write gap 26. An upper magnetic pole 27 is also provided.

When the medium magnetic field produced by the magnetic disk 16 in accordance with the recorded magnetic information is applied to the reproducing magnetic head 24 of this embodiment, which is held between the lower shield 23 and the upper shield 25, magnetizing directions of the first free-magnetic layer and the second free-magnetic layer respectively rotate independently as shown in FIG. 6(b). A change in the relative angle of the magnetizing directions of the first free-magnetic layer and the second free-magnetic layer is almost doubled in comparison with the reproducing magnetic head of the related art. Therefore, it is possible to provide a high-density and large-capacity magnetic recording apparatus by detecting changes in resistance in accordance with the relative angle of such magnetizing directions as an electric signal through the conductive wire 20.

The present invention is not limited to the specifically disclosed embodiments, and variations and modifications may be made without departing from the scope of the present invention.

What is claimed is:

1. A reproducing magnetic head reading from a medium forming a medium facing plane comprising:
a first free-magnetic layer;
a second free-magnetic layer;
a non-magnetic layer provided between said first free-magnetic layer and said second free-magnetic layer;
a bias applying layer having a single region for applying a bias magnetic field in a direction perpendicular to the medium facing plane of said first free-magnetic layer and said second free-magnetic layer; and
an electrode electrically connected to said first free-magnetic layer, said second free-magnetic layer, and said non-magnetic layer,
wherein magnetizations of said first free-magnetic layer and said second free-magnetic layer are tilted in opposite directions from a direction perpendicular to the medium facing plane in response to a magnetic field generated when a current is applied to said first free-magnetic layer, said second free-magnetic layer, and said non-magnetic layer in the direction perpendicular to the medium facing plane.

2. The reproducing magnetic head according to claim 1, wherein magnetizations of said first free-magnetic layer and said second free-magnetic layer are tilted in opposite directions by 30° to 60° in terms of the angle of elevation φ with respect to the medium facing plane for each free-magnetic layer.

3. The reproducing magnetic head according to claim 1, wherein said bias applying layer is electrically connected at an end of the head opposed to the media opposing plane, said biasing layer being electrically connected with said first free-magnetic layer, said second free-magnetic layer, and said non-magnetic layer.

4. The reproducing magnetic head according to claim 2, wherein said bias applying layer is electrically connected at an end of the head opposed to the media opposing plane, said biasing layer being electrically connected with said first free-magnetic layer, said second free-magnetic layer, and said non-magnetic layer.

5. The reproducing magnetic head according to claim 1, wherein magnetizations of said first free-magnetic layer and said second free-magnetic layer are tilted in opposite directions by 40° to 50° in terms of the angle of elevation φ with respect to the medium facing plane for each free-magnetic layer.

6. The reproducing magnetic head according to claim 1, wherein said electrode is directly connected to said first free-magnetic layer, said second free-magnetic layer, and said non-magnetic layer.

7. The reproducing magnetic head according to claim 6, wherein an underlayer is directly connected to said first free-magnetic layer, said second free-magnetic layer, said non-magnetic layer, and said bias layer.

8. The reproducing magnetic head according to claim 1, wherein a thickness of said first free-magnetic layer is about 4 nm.

9. The reproducing magnetic head according to claim 1, wherein a thickness of said second free-magnetic layer is about 4 nm.

10. The reproducing magnetic head according to claim 1, wherein a thickness of said bias applying layer is about 15 nm.

11. The reproducing magnetic head according to claim 8, wherein a thickness of said non-magnetic layer is about 1.5 nm.

12. The reproducing magnetic head according to claim 1, wherein a thickness of said electrode is about 80 nm.

13. A magnetic reproducing apparatus comprising:
a magnetic disk having a medium facing plane;
a reproducing magnetic head for reading recorded information from said magnetic disk, said head comprising:
a first free-magnetic layer;
a second free-magnetic layer;
a non-magnetic layer provided between said first free-magnetic layer and said second free-magnetic layer;
a bias applying layer having a single region for applying a bias magnetic field in a direction perpendicular to said medium facing plane of said first free-magnetic layer and said second free-magnetic layer; and
an electrode electrically connected to said first free-magnetic layer, said second free-magnetic layer, and said non-magnetic layer,
wherein magnetizations of said first free-magnetic layer and said second free-magnetic layer are tilted in opposite directions from a direction perpendicular to the medium facing plane in response to a magnetic field generated when a current is applied to said first free-magnetic layer, said second free-magnetic layer, and said non-magnetic layer in the direction perpendicular to the medium facing plane;
a flexible suspension bonded to said reproducing magnetic head;
an actuator arm which can freely rotate for fixing an end part of said suspension; and
a detecting circuit device which is electrically connected to said reproducing magnetic head through an insulated wire on said suspension and said actuator arm to detect an electrical signal read from said magnetic disk with said reproducing magnetic head.

14. The reproducing magnetic head according to claim 13, wherein magnetizations of said first free-magnetic layer and said second free-magnetic layer are tilted in opposite directions by 30° to 60° in terms of the angle of elevation φ with respect to said medium facing plane for each free-magnetic layer.

15. The reproducing magnetic head according to claim 13, wherein said electrode is directly connected to said first free-magnetic layer, said second free-magnetic layer, and said non-magnetic layer.

16. A reproducing magnetic head comprising:
an electrode;
a bias applying layer having a single region opposed to said electrode;
a first free-magnetic layer having an end electrically connected to said electrode and another end electrically connected to said bias applying layer;
a second free-magnetic layer having an end electrically connected to said electrode and another end electrically connected to said bias applying layer;
a non-magnetic layer having an end electrically connected to said electrode and another end electrically connected to said bias applying layer, and said non-magnetic layer provided between said first free-magnetic layer and said second free-magnetic layer.
